(19) United States
(12) Patent Application Publication
(10) Pub. No.: US 2010/0180563 A1
(43) Pub. Date: Jul. 22, 2010

(54) EASILY ALKALI SOLUBLE POLYESTER AND METHOD FOR PRODUCING THE SAME

(75) Inventors: Vikas Madhusudan Nadkarni, Pune (IN); Santosh Raghavendra Huilgol, Pune (IN); Shilpa Girish Nayak, Mumbai (IN); Ashwin Kumar Jain, Mumbai (IN); Makarand Renukadas Megde, Nanded (IN); Sanjay Kesarwani, Pune (IN)

Correspondence Address: Nadkarni Vikas;C/o Inventillect Consultancy Services Pvt Ltd, 102 Shree Vidyanand Dr Ketkar Road, Erandwane, Pune, 411004, IN

(73) Assignee: RELIANCE INDUSTRIES LIMITED, RIGAD (IN)

(21) Appl. No.: 12/524,167

(22) PCT Filed: Mar. 30, 2007
(86) PCT No.: PCT/IN07/00137

§ 371 Date: Jul. 23, 2009

(30) Foreign Application Priority Data
Jan. 23, 2007 (IN) 134/MUM/2007

(51) Int. Cl. D02G 3/02; C08G 63/16; C08L 67/02

(52) U.S. Cl. 57/200; 528/302; 525/418; 57/362

(57) ABSTRACT

The present invention discloses an easily alkali soluble polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester polyol. The polyester is produced by esterifying at least one dicarboxylic acid or monoesters thereof or diesters thereof and at least one diol alongwith at least one acid anhydride at a temperature in the range of 250 to 290° C. and pressure in the range of 0 to 5 kg/cm²g; and polycondensing the esterified mixture along with at least one sodium or lithium based aromatic compound and at least one hydroxyl terminated polyether polyol at temperature in the range of 250 to 290° C. and under vacuum of 0.1 to 10 torr. The invention further discloses bicomponent filament yarns or staple fibers comprising the above easily alkali soluble polyester as one polymer component and any filament or fiber forming polymer as a second polymer component and process for producing the same.

### TECHNICAL FIELD

The invention relates to an easily alkali soluble polyester comprising at least one dicarboxylic acid or monoesters thereof or diesters thereof; at least one diol or polyol; at least one carboxylic acid anhydride; at least one sodium or lithium based aromatic co-monomer and at least one hydroxyl terminated polyester polyol.

The invention also relates to a process for the production of the above easily alkali soluble polyester.

The invention also relates to bi-component filament yarns or staple fibers in islands-in-sea or segmented pie configuration, the filament yarns or staple fibers comprising the above easily alkali soluble polyester and processes for the production thereof.

### BACKGROUND AND PRIOR ART

The prior art mainly discloses the easily alkali or water soluble polyester composition and process for the production thereof by using either sodium or lithium based aromatic co-monomer such as sulfoisophthalate salts or polyethylene glycol or isophthalic acid or adipic acid either alone or in combination thereof.

In some of the cases a very high (>10%) amount of sodium sulfoisophthalate is used. This essentially makes the polymer amorphous and expensive. The use of isophthalic acid in excess of 5-mole % has also been indicated in the literature. Some researchers have used a very high molecular weight (more than 60,000) polyalkylene oxide in the weight ratio of up to 20% to make a polymer, which is soluble in hot water, however such a polymer may not have adequate thermal stability at melt spinning temperature of polyesters.

KR 2003009788 discloses a process for producing alkali-easily extractable polyester by copolymerizing and/or blending 4-9 mol % (based on terephthalic acid or ester derivatives thereof as a main component) of di-Me sulfoisophthalate lithium salt(DMIS-Li) as an alkali-easily extractable monomer in the polymerization of polyethylene terephthalate.

JP 3601902 discloses polyamide hollow conjugate fiber having fine pours and openings, excellent in properties of absorbing and discharging moisture. One of the component used is easily alkali soluble polyester, PET, which is prepared by copolymerizing polyethylene glycol with sodium salt of 5-sulfoisophthalic acid.

KR 175432 discloses a process of preparing easily soluble co-polyester by ester exchange reaction of di-Me 5-sodosulfoisophthalate with di-Me terephthalate and ethylene glycol and adding with polyalkylene glycol as a copolymer component. The above easy soluble co-polyester can be used for manufacturing composite fibers such as ultrafine fibers or modified cross-section fibers. The polyester is easily soluble due to use of di-Me 5-sodosulfoisophthalate and polyalkylene glycol.

JP 62257460 discloses yarns with high latent bulk which is prepared by twisting spun yarns and easily alkali-soluble polyester fibers. Easily alkali soluble polyester disclosed here is ethylene glycol-isophthalicacid-sodium sulfoisophtharate-terephthalic acid copolymer containing 2.5 mol % Na sulfoisophthalate units and 5.5 mol % isophthalic acid units which was melt spun and drawn. These fibers and cotton yarns were twisted, woven into a fabric, and treated with an aqueous composition containing 4% NaOH for 30 min at 98° C. to dissolve the easily alkali soluble polyester resulting into a fabric with high bulk and soft handle.

JP 62078213 describes polyester fibers with silk like handle and luster. The polyester fibers are prepared by melt spinning together an easily alkali-soluble polyester containing metal sulfonate units and polyalkylene glycol units and an alkali-insoluble polyester containing ethylene terephthalate units to form fibers with the surface partially containing the easily alkali-soluble polyester component. These fibers were treated with 3% NaOH at 98° C. to dissolve easily alkali-soluble polyester, and dyed to give a fabric with silk like handle and luster. The main object of the above product is to have good dyeability.

JP 61102473 discloses polyester fabrics for garments having improved drape and handle. The fabric was prepared by melt spinning together a polyester having low alkali solubility and an easily alkali-soluble polyester containing 1-5 Na 5-sulfoisophthalate units and 2-10 mol % adipic acid units to give fibers with a Y-shaped cross section and converted into fabric by waving. The fabric was treated with an alkali (30 g/L NaOH) for 30 min at 100° C. to give a fabric with wt. loss 20% and excellent drape and soft handle

JP 57193572 discloses a process for producing a fabric by producing a polyester composite fiber consisting of easily alkali soluble constituents containing 3-12% polyalkylene glycol and/or anionic surfactant and ≦70% ethylene terephthalate units and constituents hardly soluble in alkali containing ≦80% ethylene terephthalate and/or butylene terephthalate units; preparing a fabric from the polyester composite fibers; and dissolving the easily soluble constituents in alkali solution (8 g/L caustic soda solution) at 110-150° C.

JP 2000073234 discloses fibers comprise a hollow, a core of moisture-absorbing and -releasing thermoplastics, a polyester interlayer, and a sheath easily soluble in alkalies. The easily alkali soluble polyester used is 5-sodiosulfoisophthalate-polyethylene glycol-terephthalic acid copolymer.

JP2004231925 discloses polyester having high solubility in hot water which is used as an elutable component for various molded articles. The hot-water-soluble polyester composition has 7-20 mol % of sulfoisophthalic acid metal salt and 1-20 wt. % of polyalkylene oxide having a number-average molecular weight of at least 60,000

JP2000314036 discloses a lightweight hollow false twist textured yarn scarcely causing convection of air in the interior of clothes and excellent in heat insulating properties. It also discloses the easily soluble polyester comprises both metal sulfoisophthalate and polyalkylene glycol.

JP11256424 discloses a mixed polyester fiber that gives woven or knitted fabrics having excellent color-developing properties with squeaky feeling, dry feeling and harshness and is useful as high-class clothes by extending admixed blending components in the fiber axis direction and then removing the blending components from the fibers. The easily soluble polyester used here is made of 5-sodiosulfo-isophthalic acid and isophthalic acid.

Most of the patents/patent applications reported in the prior art use sodium or lithium salt of aromatic co-monomer such as sulfoisophthalic acid or esters thereof (CD-Salts) to make easily alkali soluble polyester. The CD-salts are costly and loading in excess of 4% is needed when used alone to produce easily alkali soluble polyester. As the concentration of CD-salt increases the process and product will become costly. Use of higher concentration of CD-salt in the polymer also may lead to gel formation and may also cause batch-to-batch variation in the product quality. The main disadvantage of the use of high concentration of CD-salt in the easily alkali soluble polyester is that due to its highly branched structure, polymer obtained is difficult to spin. Further the polymer chips are very difficult to handle without crystallization while transporting to other unit for further processing.

Some of the patents/patent applications reported in the prior art use polyalkylene oxide to make easily alkali soluble polyester. However, polyalkylene oxide is prone to degradation in the polymerization condition and hence affecting the quality of the product. Therefore one has to modify and/or control the polymerization conditions to avoid degradation of the polyalkylene glycol. Also its linear structure reduces the melting viscosity of the polymer. The polymer may not have adequate thermal stability at melt spinning temperature and hence making downstream processing difficult. Selection of polyalkylene oxide of particular molecular weight and its concentration is very important in the production of easily alkali soluble polyester.

Some of the patents/patent applications reported in the prior art use adipic acid to make easily soluble polyester. Although use of the adipic acid as a co-monomer increases alkali solubility due to its chain flexibility, but at the same time the polymer obtained has lower melting point leading to difficulties in spinning.

However, some of the prior arts use very harsh conditions for the dissolution of the polyester.

Thus, there are number of compositions available for making polymer easily alkali soluble, but the challenges are to make the rate of dissolution fast. This is to reduce the surface hydrolysis of microdenier island components, when polyethylene terephthalate is used as ‘island’ polymer and the easily alkali soluble polymer as a ‘Sea’ polymer. Secondly, the rate of polymerization should not be adversely affected by incorporation of various co-monomers. The melt elongational viscosity of the polymer at the spinning temperatures should be such that the fibers can be spun at conventional speeds and formed into a set of filaments. Finally the cost of the composition and process of preparing the polymer should be economically viable.

Further all the prior art discloses the use of adipic acid, isophthalic acid, CD-salt and Polyalkylene glycol either alone or in combinations thereof to make easily soluble polyester. Based on the prior art search carried out by us, we do not come across a single prior art, which discloses the easily alkali soluble polyester of the present invention.

### OBJECTS

An object of the invention is to provide an easily alkali soluble polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester polyol, having uniform dissolution pattern.

Another object of the invention is to provide an easily alkali soluble polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester polyol, having IV of about 0.55 to 0.64 which is easy to spin and further ease in down stream dissolution processing with alkali treatment.

Another object of the invention is to provide an easily alkali soluble polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester polyol, having IV of about 0.6 which have characteristic rheological parameters to allow distinct islands formation without causing agglomeration of neighboring islands even at higher number of islands, when used as a polymer component in islands-in-sea bicomponent yarns

Another object of the invention is to provide an easily alkali soluble polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester polyol, having IV of about 0.6 where the quality of the product is consistent.

Another object of the invention is to provide an easily alkali soluble polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester polyol, having IV of about 0.6 where the product is cost-effective.

Another object of the invention is to provide an easily alkali soluble polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester polyol, having IV of about 0.6 by using carboxylic acid anhydride such as phthalic anhydride which is cost effective, readily available, reduces crystallinity and hence accelerates dissolution.

Another object of the invention is to provide a process for the preparation of an easily alkali soluble polyester, said polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester polyol, by using less concentration of sodium or lithium based aromatic co-monomer (i.e. CD-salt) and hydroxyl terminated polyester polyol (i.e. PEG) and hence the process is cost-effective.

Another object of the invention is to provide a process for the preparation of an easily alkali soluble polyester, said polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester polyol, by using less concentration of CD-salt and PEG and hence the process is simple and easy to carry out.

Another object of the invention is to provide a process for the preparation of an easily alkali soluble polyester, said polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester polyol, by using less concentration of CD-salt and PEG and hence the process gives product with consistent quality.

Another object of the invention is to provide a process for the preparation of an easily alkali soluble polyester, said polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester polyol, by using carboxylic acid anhydride such as phthalic anhydride and hence the process gives product with lower crystallinity, controlled melt rheology, and hence faster dissolution.

Another object of the invention is to provide bi-component filament yarns or staple fibers comprising the above easily alkali soluble polyester as one polymer component wherein the product is made by using various geometries, such as, segmented-pie or islands-in-sea.

Another object of the invention is to provide bi-component filament yarns or staple fibers comprising the above easily alkali soluble polyester as one polymer component wherein the product is easily spinnable and readily processible in the drawing/annealing step.

### DETAILED DESCRIPTION

According to the invention there is provided an easily alkali soluble polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester polyol.

According to the invention there is provided a process for producing an easily alkali soluble polyester, comprising:
(a) esterifying at least one dicarboxylic acid or monoesters thereof or diesters thereof and at least one diol in the range of the molar ratio of 1:1 to 1:2 along with at least one acid anhydride at a temperature in the range of 250 to 290° C. and pressure in the range of 0 to 5 kg/cm²g; and
(b) polycondensing the esterified mixture along with at least one sodium or lithium based aromatic compound and at least one hydroxyl terminated polyether polyol in the presence of catalyst at temperature in the range of 250 to 290° C. and under vacuum of about 0.1 to 10 ton.

The carboxylic acid anhydride is used in the range of 2 to 10% w/w based on the polymer. The carboxylic acid anhydride used is selected from phthalic anhydride, maleic anhydride, trimellitic anhydride or pyromellitic dianhydride. The main objective of using this comonomer is to introduce adequate amorphicity in the fibers so that the access of hydrolyzing media to dissolve out the sea component is faster. The sodium or lithium based aromatic co-monomer is used in the range of 1 to 10% w/w based on the polymer. The sodium or lithium based aromatic co-monomer is selected from sulfoisophthalic acid, methyl ester thereof or bishydroxy ethyl ester thereof. The hydroxyl terminated polyester polyol is used in the range of 2 to 20% w/w based on the polymer. The hydroxyl terminated polyether polyol is selected from polyethylene glycol or polypropylene glycol having molecular weight in the range of 400 to 6000. The dicarboxylic acid or monoesters thereof or diesters thereof is selected from terephthalic acid, isophthalic acid, naphthalene dicarboxylic acid, glutaric acid, adipic acid, azelaic acid or sebacic acid. The diol is selected from ethylene glycol, diethylene glycol, triethylene glycol, propylene glycol, butanediol, 1,3-propane diol, or neopentyl glycol. The ratio of dicarboxylic acid or monoester thereof or diester thereof to diol is in the range of the molar ratio of 1:1 to 1:2. The above process is batch or continuous process. The above process is optionally carried out in the presence of thermal stabilizer selected from organic phosphorous compounds or inorganic phosphorous compounds. The above process is optionally carried out in the presence of toner to reduce the color of polyester.

According to the invention there is provided a bi-component filament yarns or staple fibers comprising one polymer component as the easily alkali soluble polyester, said easily polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester polyol and second polymer component as filament or fiber forming polymer.

According to the invention there is provided a process for producing the above bi-component filament yarns, the process comprising extruding the two polymer components consisting of the easily alkali hydrolysable polyester, said polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester polyol, as a one polymer component and filament or fiber forming polymer as a second polymer component in a separate extruder; and spinning the extrudate of both the polymer components to obtain bi-component filament yarns of any bicomponent cross-section including segmented-pie or islands-in-sea.

According to the invention there is provided a process for producing bicomponent staple fibers, the process comprising extruding the two polymer components consisting of the easily alkali hydrolysable polyester, said polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester polyol, as one polymer component and any filament or fiber forming polymer as second polymer component in a separate extruder; spinning the extrudate of both the polymer components at speed of 800 to 1600 mpm; drawing the spun tow at speed of 80 to 250 mpm and crimping the tow and cut into staple fibers of 24 to 51 mm in length to obtain bi-component staple fibers of any bicomponent cross-section including segmented-pie or islands-in-sea.

Fiber or filament forming polymer is selected from polyesters having IV in the range of 0.4 to 0.8, particularly polyethylene terephthalate or polybutylene terephthalate or polytrimethylene terephthalate or copolymers thereof or other polymers such as polypropylene, polyethylene, polylactic acid, nylons, etc. The two polymer components of the bi-component filament yarns or staple fibers are used in the ratio of 20:80 to 80:20. The two polymer components of the bi-component filament yarns or staple fibers are configured in either segmented pie or islands-in-sea bicomponent geometry. The easily alkali soluble polyester is used as a sea component or island component. The cross section of the above bi-component filament yarns or staple fibers could be trilobal or circular or any other cross-section. The bi-component filament yarns is fully drawn yarn or partially oriented yarn and subsequently textured or partially oriented yarn and subsequently draw twisted. The process is single stage process (Fully drawn yarn (FDY)) or two-stage process (partially oriented yarn (POY) followed by texturing).

The spinning of the polymer can be carried out to produce FDY in the speed range of 3000 to 5500 or to produce POY in the speed range of 2500 to 3300 meters per minute. Further, POY yarns can be textured in the speed range of 300 to 800 meters per minute. The spinning of the polymer can be carried out at 600-1800 meters per minute for producing spun tow, to be converted into staple fibers through drawline processing.

The two different polymers follow different flow paths from the extruder to the capillary inlet, arranging themselves into a form of islands-in-sea or solid segmented-pie or hollow segmented pie in cross section geometry. The number of islands is in the range of 10 to 600, preferably the number of islands is in the range of 12 to 64. The melt viscosity ratio of the two polymers during filament extrusion was controlled so as to achieve perfect islands-in-sea geometry. Imbalance in melt viscosity will lead to fusing of islands or merging of islands and sea component together thus completely marring the objective. The number of segments in segmented pied geometry could be in the range of 8 to 32.

The FDY process comprising extruding two polymer components in separate extruders and passing through the pack towards the capillary to obtain a bicomponent filament yarns having circular or trilobal or any other cross-section; quenching the filament yarns at quenching zone at temperature in the range of 14° C. to 25° C.; spinning the filament yarn at speed in the range of 1000 to 2500 meters per minute; passing the yarn over a pair of draw rollers heated between 60° C. to 180° C.; drawing the yarn at speed in the range of 3300 to 5500 meters per minute and winding the yarn on bobbins at speed in the range of 3300 to 5500 meter per minute to obtain fully drawn yarn.

The draw was maintained in the range of 1.6 to 3.2 depending upon the winding speed, denier per filament, polymer combination and the mass contribution of polymers in the bicomponent filament yarns. In this process, the filaments were drawn and heat set on a set of rollers, followed by controlled relaxation prior to winding of yarn over the bobbin. The final mechanical properties of the bicomponent filament yarns achieved in single stage process are comparable to the homo polymer FDY required for further processing into fabric stage.

The POY process comprising extruding the two polymers in separate extruders and passed through the pack towards the capillary to obtain bicomponent filament yarns having circular or trilobal or any other cross-section; quenching the filament yarns at quenching zone at temperature in the range of 14° C. to 25° C.; spinning the filament yarns at speed in the range of 2500 to 3500 meters per minute; passing the yarn over cold godets after suitable spin finish application and winding the yarn on the bobbins in the speed range of 2500 to 3500 mpm to produce a partially oriented yarn.

The spinning speed of the partially oriented yarn is at least 2500 m/min; preferably 2900-3300 m/min. The required product attributes like draw tension, residual elongation and natural draw ratio were achieved by optimizing melt spinning process conditions e.g. spinning speed, melt temperature, quenching conditions, etc. The winding tension was maintained in such a manner that the yarn can be easily unwound in the downstream process.

The polymers are directly fed from the outlet of the finisher vessel from the continuous polymerizer or chips of two polymers fed to the extruder. Optionally the delustrant is added to polymer components to reduce the luster of the filament yarns or staple fibres. The delustrant is present in the polymers in the range of 0% to 2.5% on weight of that respective polymer.

Preferably, the partially oriented yarn is processed by friction texturing or air texturing route by single end texturing or co-texturing methods or draw-twisting machine to achieve the final properties comparable to homo-polymer yarns comparably processed. The partially oriented yarn was draw textured to obtain yarns to enhance the bulk. The yarn was passed through the primary heater in the temperature range of 150 to 190° C. depending upon the several factors including the processing speed; heater length and heat transfer method like direct contact or convection. The bicomponent yarns can be successfully textured using the disc materials ranging from ceramic to polyurethane. The POY was drawn at the draw ratio ranging from 1.4 to 1.9 depending upon the characteristics of the POY and final targeted properties. Tenacity and elongation response to draw ratio is similar as compared to the conventional homo PET filaments. The texturing speeds were in the range of 300 to 800 m/min.

The partially oriented bicomponent yarn is also processed through draw twisting route apart from false twist texturing process. The filament yarns are passed over the heated rollers within the temperature range of 100 to 150° C. The draw ratio is adjusted but not limited to in the range of 1.2 to 1.8 depending upon the required final characteristics. The filament yarns are passed over a heater plate for heat setting the yarn. The filament yarns can also be also doubled with another yarn having different shrinkage properties to provide bulk into the fabric. The speed of draw twisting machine was in the range of 400 to 1000 m /min. Preferably, the partially oriented yarn is processed through false-twist texturing process in the range of 400 to 800 mpm take-up speeds.

The fully drawn yarns or textured yarns are optionally twisted before processing into fabrics. Preferably, the fully drawn yarns are twisted in ‘S’ or ‘Z’ direction in the range of 200 to 2700 turns per meter and heat set in the temperature range of 80° C. to 95° C. with or without use of vacuum in single or multiple cycles before further processing.

The bicomponent yarns or staple fibers can be treated with 2 to 8% of alkali at a temperature in the range of 80 to 130° C. for the residence time for 10 to 60 min to obtain the ultramicrodenier bicomponent filament yarns or staple fibers. The denier of the ultramicrodenier bicomponent filament yarns or staple fibers thus produced are of the order of 0.01 to 0.3 dpf.

The present polyester has phthalic anhydride, which replaces part of the CD-salt and polyalkylene glycol and has good solubility characteristics. As the quantity of the CD-salt and polyalkylene glycol used in the polyester is small as compared to the prior art and the condition employed to the polymerization is normal, thereby making the process simple and easy to carry out. We also did not come across any degradation in the polymerization and the quality of the product is consistent. Phthalic anhydride due to its non-linear structure reduces crystallinity leading to faster dissolution characteristics of the polyester of the invention. Thus the polymer is easily alkali soluble and does not require very harsh condition. As the invention uses CD-salt less as compared to the prior art, thereby making the products cost-effective. The easily alkali soluble polyester has uniform dissolution pattern. The polyester has IV of about 0.6 thereby making the polymer easy to spin and further ease in down stream dissolution processing with alkali treatment. It has characteristic rheological parameters and when it is configured in sea-island geometry results into distinct islands without causing agglomeration of neighboring islands even at higher number of islands such as 64.

Although the invention has been described with reference to specific examples, it will be appreciated by those skilled in the art that the invention may be embodied in many other forms.

### EXAMPLE 1

Pure terephthalic acid (PTA) and Monoethylene glycol (MEG) in the mole ratio of 1:2 were esterified in the mole ratio of 1:2 at temperature in the range of 250° C. to 290° C. and under nitrogen pressure of 1 to 2 kg/cm²g. Water, formed during the esterification reaction and excess MEG were removed, which was then cooled and recovered. To the esterified mixture, catalyst, Sb₂O₃ (250 ppm Sb in polymer); thermal stabilizer, H₃PO₄ (30 ppm P in polymer); toner, cobalt acetate (25 ppm in polymer); and bishydroxyethyl ester of sulfoisophthalic acid, in the range of 3.7% based on the weight of the polymer were added. The reaction mixture was polycondensed at temperature around 250 to 290° C. and under vacuum around 1 mm Hg.

The polymer formed was drained into strands and quenched in water bath. The strands were cut into chips in a pelletizer. The copolyester chips were melt spun in a spinning machine in the form of filament and its solubility was checked for 20 min in 2% boiling alkaline solution. The results are tabulated in Table I.

### EXAMPLE 2

PTA and MEG were esterified in the mole ratio of 1:2 along with 5% wt/wt phthalic anhydride based on polymer at temperature of 250° C. to 290° C. and under nitrogen pressure of 1 to 2 kg/cm²g. Water formed during the esterification reaction and excess MEG was removed, which was then cooled and recovered. To the reaction mixture, catalyst, Sb₂O₃ (250 ppm Sb in polymer); thermal stabilizer, H₃PO₄ (30 ppm P in polymer); toner cobalt acetate (25 ppm in polymer); polyether polyols of Mol wt 1500, in the range of 10% based on the weight of the polymer and bishydroxyethyl ester of sulfoisophthalic acid, in the range of 3.7% based on the weight of the polymer, were added. The reaction mixture was then polycondensed at temperature of 250 to 290° C. and under vacuum at around 1 mm Hg.

The polymer obtained was drained into strands and quenched in water bath. The strands were cut into chips in a pelletizer. The copolyester chips were melt spun in a spinning machine in the form of filament and its solubility was checked for 20 min in 2% boiling alkaline solution. The results are tabulated in Table I.

### EXAMPLE 3

PTA and MEG were esterified in the mole ratio of 1:2 along with 5% wt/wt isophthalic acid based on polymer at temperature of 250° C. to 290° C. and under nitrogen pressure of 1 to 2 kg/cm²g. Water formed during the esterification and excess MEG were removed, which was then cooled and recovered. To the reaction mixture, the catalyst, Sb₂O₃ (250 ppm Sb in polymer); the thermal stabilizer, H₃PO₄ (30 ppm P in polymer); toner, cobalt acetate (25 ppm in polymer); polyether polyols of Mol wt 400, in the range of 5% based on the weight of the polymer and bishydroxyethyl ester of sulfoisophthalic acid, in the range of 3.7% based on the weight of the polymer were added. The reaction mixture was polycondensed at temperature of 250 to 290° C. and under vacuum of around 1 mm Hg.

The polymer formed was drained into strands and quenched in water bath. The strands were cut into chips in a pelletizer. The copolyester chips were melt spun in a spinning machine in the form of filament and its solubility was checked for 20 min in 2% boiling alkaline solution. The results are tabulated in Table I.

### EXAMPLE 4

PTA and MEG were esterified in the mole ratio of 1:2 at temperature in the range of 250° C. to 290° C. and under nitrogen pressure of 1 to 2 kg/cm²g. Water formed during the esterification reaction, and excess MEG was removed, which was then cooled and recovered. To the esterified mixture, catalyst, Sb₂O₃ (250 ppm Sb in polymer); thermal stabilizer, H₃PO₄ (30 ppm P in polymer); toner, cobalt acetate (25 ppm in polymer); polyether polyols of mol wt 200, in the range of 5% based on the weight of the polymer and bishydroxyethyl ester of sulfoisophthalic acid, in the range of 3.7% based on the weight of the polymer were added. The reaction mixture was polycondensed at temperature in the range of 250 to 290° C. and under a vacuum of around 1 mm Hg.

The polymer obtained was drained into strands and quenched in water bath. The strands were cut into chips in a pelletizer. The copolyester chips were melt spun in a spinning machine in the form of filament and its solubility was checked in 2% boiling alkaline solution. The results are tabulated in Table I.

### EXAMPLE 5

PTA and MEG were esterified in the mole ratio of 1:2 along with 5% wt/wt phthalic anhydride at temperature of 250° C. to 290° C. and under nitrogen pressure of 1 to 2 kg/cm²g. Water formed during the esterification reaction and excess MEG was removed, which was then cooled and recovered. To the estrified mixture, catalyst, Sb₂O₃ (250 ppm Sb in polymer); thermal stabilizer, H₃PO₄ (30 ppm P in polymer); toner, cobalt acetate (25 ppm in polymer); polyether polyols of mol wt 600, in the range of 5% based on the weight of the polymer and bishydroxyethyl ester of sulfoisophthalic acid, in the range of 3.7% based on the weight of the polymer were added. The reaction mixture was polycondensed at temperature around 250 to 290° C. and under vacuum of around 1 mm Hg.

The polymer formed was drained into strands and quenched in water bath. The strands were cut into chips in a pelletizer. The copolyester chips were melt spun in a spinning machine in the form of filament and its solubility was checked for 20 min in 2% boiling alkaline solution. The results are tabulated in Table I.

### EXAMPLE 6

PTA and MEG were esterified in the mole ratio of 1:2 along with 5% wt/wt phthalic anhydride at temperature of 250° C. to 290° C. and under nitrogen pressure of 1 to 2 kg/cm²g. Water formed during the esterification reaction and excess MEG was removed, which was then cooled and recovered. To the estrified mixture, catalyst, Sb₂O₃ (25 ppm Sb in polymer); thermal stabilizer, H₃PO₄ (30 ppm P in polymer); toner, cobalt acetate (25 ppm in polymer); polyether polyols of mol wt 600, in the range of 10% based on the weight of the polymer and bishydroxyethyl ester of sulfoisophthalic acid, in the range of 3.7% based on the weight of the polymer were added. The reaction mixture was polycondensed at temperature around 250 to 290° C. and under vacuum of around 1 mm Hg.

The polymer formed was drained into strands and quenched in water bath. The strands were cut into chips in a pelletizer. The copolyester chips were melt spun in a spinning machine in the form of filament and its solubility was checked for 20 min in 2% boiling alkaline solution. The results are tabulated in Table I.

### EXAMPLE 7

PTA and MEG were esterified in the mole ratio of 1:2 along with 10 weight percent anhydride based on polymer at temperature of 250° C. to 290° C. and under nitrogen pressure of 1 to 2 kg/cm²g. Water formed during the esterification reaction and excess MEG was removed which was then cooled and recovered. To the reaction mixture, catalyst, Sb₂O₃ (250 ppm Sb in polymer); thermal stabilizer, H₃PO₄ (30 ppm P in polymer); toner, cobalt acetate (25 ppm in polymer); polyether polyols of Mol Wt 600, in the range of 5% based on the weight of the polymer and bishydroxyethyl ester of sulfoisophthalic acid, in the range of 3.7% by weight of the polymer were added. The reaction mixture was polycondensed at temperature around 250 to 290° C. and under vacuum 1 mm Hg.

The polymer formed was drained into strands and quenched in water bath. The strands were then cut into chips in a pelletizer. The copolyester chips were melt spun in a spinning machine in the form of filament and its solubility was checked for 20 min in 2% boiling alkaline solution. The results are tabulated in Table I.

TABLE I

| Example | % Dissolution |
|---|---|
| Example 1 | 17.5 |
| Example 2 | 99.6 |
| Example 3 | 34.0 |
| Example 4 | 39.0 |
| Example 5 | 60.0 |
| Example 6 | 95.0 |
| Example 7 | 90.0 |

### EXAMPLE 8

The easily alkali soluble polyester produced according to example 2 and standard polyester of 0.61 IV were melt-processed through bicomponent spinning machine to configure the polymers in islands-in-sea bicomponent geometry comprising sixty-four islands. The weight ratio of easily alkali soluble polyester to standard polyester in the bicomponent fiber was 25:75. The filaments were processed through the single stage process route to get a set yarn.

As the filaments come out of the capillary they are quenched by cross flow air at a temperature of 20° C. and then passed over the heated godet roller I at the temperature of 80° C. at a speed of 1364 meters/minute and drawn at the draw ratio of 2.8 at winding speed of 3800 m/min. The yarn was annealed over the godet roller II at temperature of 145° C. The properties of fully drawn bicomponent yarn are shown in table II.

TABLE II
Physical properties of bicomponent FDY

| Sr. No. | Property | Unit | Value |
|---|---|---|---|
| 1 | Tenacity | gpd | 4.0 |
| 2 | Elongation | % | 39 |
| 3 | Boiling Water Shrinkage | % | 6.4 |
| 4 | Finish on yarn | % | 1.1 |

The fabric produced by using this yarn was subjected to the alkali treatment, (2% of sodium hydroxide solution at temperature of 100° C. for residence time of 30 minutes) which results into the splitting of each filament into the ultrafine microfilaments. Ultrafinemicrodenier filaments produced were in the order of 0.02 to 0.06 dpf and evenly distributed in the fabric matrix.

### EXAMPLE 9

The easily alkali soluble polyester produced according to example of 2 and standard polyester of 0.61 IV were melt-processed through bicomponent spinning machine to configure the polymers in islands-in-sea bicomponent geometry comprising sixty-four islands. The weight ratio of the easily alkali soluble polyester to standard polyester in the bicomponent fiber was 25:75. The filaments were processed over cold godets to get a partially oriented yarn (POY). The properties of bicomponent partially oriented yarn are shown in table III.

As the filaments come out of the capillary they are quenched by cross flow air at a temperature of 20° C. and then passed over the godet roller I at a speed of 2945 meters/minute and passed over godet roller II at a speed of 2925 meters/minute and wound on bobbins at a winding speed of 2940 m/min. The properties of fully drawn bicomponent yarn are shown in table III.

TABLE III
Physical properties of bicomponent POY

| Sr. No. | Property | Unit | Value |
|---|---|---|---|
| 1 | Tenacity | gpd | 2.3 |
| 2 | Elongation | % | 132 |
| 3 | Draw Tension | g | 40 |
| 4 | Uster | % | 1.28 |
| 5 | Finish on yarn | % | 0.35 |

The POY is texturised on a SDS 700 texturing machine at a speed of 400 m/min at a draw of 1.67. The texturing mode is false twist texturing

We claim:

1. A spinnable, gel-free and thermally stable polyester composition that dissolves completely in an alkaline solution, said polyester composition comprising structural repeating units derived from:
a) at least one dicarboxylic acid or a monoester or diester thereof;
b) at least one dihydroxy alcohol;
c) at least one carboxylic acid anhydride;
d) at least one aromatic dicarboxylic acid that is substituted at one or more available positions of the benzene ring with sulphonic acid functional group, said sulphonic acid being neutralized in the form of an alkali metal salt; and
e) at least one hydroxyl-terminated polyether polyol,
wherein the structural repeating units derived from c, d and e constitute 1 to 15 weight %, 1 to 15 weight % and 1 to 25 weight %, respectively, of said polyester composition such that c and d jointly constitute 2 to 25 wt % of said polyester composition and c, d and e jointly constitute 5 to 30 wt % of said polyester composition

2. Easily alkali soluble polyester as claimed in claim 1, wherein the carboxylic acid anhydride is used in the range of 2 to 10% w/w based on the polymer.

3. Easily alkali soluble polyester as claimed in claim 1, wherein the carboxylic acid anhydride used is selected from phthalic anhydride, maleic anhydride, trimellitic anhydride or pyromellitic dianhydride.

4. Easily alkali soluble polyester as claimed in claim 1, wherein the sodium or lithium based aromatic co-monomer is used in the range of 1 to 10% w/w based on the polymer.

5. Easily alkali soluble polyester as claimed in claim 1, wherein the sodium or lithium based aromatic co-monomer is selected from sulfoisophthalic acid, methyl ester thereof or bishydroxy ethyl ester thereof.

6. Easily alkali soluble polyester as claimed in claim 1, wherein the hydroxyl terminated polyester polyol is used in the range of 2 to 20% w/w based on the polymer.

7. Easily alkali soluble polyester as claimed in claim 1, wherein the hydroxyl terminated polyether polyol is selected from polyethylene glycol or polypropylene glycol having molecular weight in the range of 400 to 6000.

8. Easily alkali soluble polyester as claimed in claim 1, wherein the dicarboxylic acid or monoesters thereof or diesters thereof is selected from terephthalic acid, isophthalic acid, naphthalene dicarboxylic acid, glutaric acid, adipic acid, azelaic acid or sebacic acid or monoesters thereof or diesters thereof.

9. Easily alkali soluble polyester as claimed in claim 1, wherein the diol is selected from ethylene glycol, diethylene glycol, triethylene glycol, propylene glycol, butanediol, 1,3 -propane diol, or neopentyl glycol.

10. Easily alkali soluble polyester as claimed in claim 1, wherein the molar ratio of dicarboxylic acid or monoester thereof or diester thereof to diols is in the range of the molar ratio of 1:1 to 1:2.

11. A process for preparing an easily alkali soluble polyester comprising:
(a) esterifying at least one dicarboxylic acid or monoesters thereof or diesters thereof and at least one diol alongwith at least one acid anhydride at a temperature in the range of 250 to 290° C. and pressure in the range of 0 to 5 kg/cm²g; and
(b) polycondensing the esterified mixture along with at least one sodium or lithium based aromatic compound and at least one hydroxyl terminated polyether polyol in the presence of catalyst at temperature in the range of 250 to 290° C. and under vacuum of 0.1 to 10 torr.

12. A process as claimed in claim 11, wherein the carboxylic acid anhydride is used in the range of 2 to 10% w/w based on the polymer.

13. A process as claimed in claim 11, wherein the carboxylic acid anhydride used is selected from phthalic anhydride, maleic anhydride, trimellitic anhydride or pyromellitic dianhydride.

14. A process as claimed in claim 11, wherein the sodium or lithium based aromatic co-monomer is used in the range of 1 to 10% w/w based on the polymer.

15. A process as claimed in claim 11, wherein the sodium or lithium based aromatic co-monomer is selected from sulfoisophthalic acid, methyl ester thereof or bishydroxy ethyl ester thereof.

16. A process as claimed in claim 11, wherein the hydroxyl terminated polyester polyol is used in the range of 2 to 20% w/w based on the polymer.

17. A process as claimed in claim 11, wherein the hydroxyl terminated polyether polyol is selected from polyethylene glycol or polypropylene glycol having molecular weight in the range of 400 to 6000.

18. A process as claimed in claim 11, wherein the dicarboxylic acid or monoester thereof or diester thereof is selected from terephthalic acid, isophthalic acid, naphthalene dicarboxylic acid, glutaric acid, adipic acid, azelaic acid or sebacic acid or monoesters thereof or diesters thereof.

19. A process as claimed in claim 11, wherein the diol is selected from ethylene glycol, diethylene glycol, triethylene glycol, propylene glycol, butanediol, 1,3 propane diol, or neopentyl glycol.

20. A process as claimed in claim 11, wherein the ratio of dicarboxylic acid or monoester thereof or diester thereof to diol or polyol is in the range of 1:1 to 1:2.

21. A process as claimed in claim 11, wherein the process is batch or continuous process.

22. Bi-component filament yarns or staple fibers, comprising one polymer component as the easily alkali soluble polyester and second polymer component as filament or fiber forming polymer; said easily polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester.

23. Bi-component filament yarns or staple fibers as claimed in claim 22, wherein the two polymer components of the bi-component filament yarns or staple fibers are used in the ratio of 20:80 to 80:20.

24. Bi-component filament yarns or staple fibers as claimed in claim 22, wherein the two polymer components of the bi-component filament yarns or staple fibers are configured in segmented pie component geometry.

25. Bi-component filament yarns or staple fibers as claimed in claim 22, wherein the two polymer components of the bi-component filament yarns or staple fibers are configured in islands-in-sea geometry.

26. Bi-component filament yarns or staple fibers as claimed in claim 22, wherein the easily alkali soluble polyester according to the claim 1 is used as a sea component or island component.

27. Bi-component filament yarns or staple fibers as claimed in claim 22, wherein the cross section of the bi-component of the filament yarns or staple fibers is trilobal or circular or any other cross-section.

28. Bi-component filament yarns as claimed in claim 22, wherein the filament yarns is fully drawn yarn (FDY) or partially oriented yarn and subsequently textured or partially oriented yarn and subsequently draw twisted.

29. A process for producing a bi-component filament yarns, the process comprising extruding the two polymer components consisting of the easily alkali soluble polyester as one polymer component and any filament or fiber forming polymer as second polymer component in a separate extruder; and spinning the extrudate of both the polymer components to obtain bi-component filament yarns; said easily alkali soluble polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester polyol.

30. A process for producing bicomponent staple fibers, the process comprising extruding the two polymer components consisting of the easily alkali soluble polyester and any filament or fiber forming polymer as second polymer component in a separate extruder; and spinning the extrudate of both the polymer components to obtain bi-component staple fibers; spinning the extrudate of both the polymer components at speed of 800 to 1600 mpm; drawing the spun tow at speed of 80 to 250 mpm and crimping the tow and cut into staple fibers of 24 to 51 mm in length; said easily alkali soluble polyester comprising at least one dicarboxylic acid or monoesters thereof or diesters thereof; at least one diol; at least one carboxylic acid anhydride; at least one sodium or lithium based aromatic co-monomer and at least one hydroxyl terminated polyester polyol, as one polymer component.

31. A process as claimed in claim 29-30, wherein the two polymer components of the bi-component of filament yarns or staple fibers are used in the ratio of 20:80 to 80:20.

32. A process as claimed in claim 29-30, wherein the two polymer components of the bi-component of filament yarns or staple fibers are spun to configure in segmented pie component geometry.

33. A process as claimed in claim 29-30, wherein the two polymer components of the bi-component of filament yarns or-staple fibers are spun to configure in islands-in-sea geometry.

34. A process as claimed in claim 29-30, wherein the easily alkali soluble polyester is used as a sea component or islands component.

35. A process as claimed in claim 29, wherein the filament yarns is fully drawn yarn (FDY) or partially oriented yarn (POY) and subsequently textured or partially oriented yarn and subsequently draw twisted.

36. The filament yarns or staple fibers as produced in any of the preceding claims wherein the sea polymer can be hydrolysed by treating with 2% to 8% alkali solution in the temperature range of 80° C. to 130° C. for a period of 10 to min to give ultramicrofilaments of 0.01 to 0.3 denier.
